(19) United States
(12) Patent Application Publication
(10) Pub. No.: US 2013/0043739 A1
(43) Pub. Date: Feb. 21, 2013

(54) APPARATUS FOR PREVENTING CORROSION OF IF CONNECTOR IN PORTABLE TERMINAL AND METHOD THEREOF

(71) Applicants: Bo-Ram Kim, Suwon-si (KR); Ho-Soo Seo, Suwon-si (KR); Seong-Cheol Kim, Yongin-si (KR)

(72) Inventors: Bo-Ram Kim, Suwon-si (KR); Ho-Soo Seo, Suwon-si (KR); Seong-Cheol Kim, Yongin-si (KR)

(73) Assignee: SAMSUNG ELECTRONICS CO., LTD., Suwon-si (KR)

(21) Appl. No.: 13/562,239

(22) Filed: Jul. 30, 2012

(30) Foreign Application Priority Data
Aug. 18, 2011 (KR) 10-2011-0082067

(51) Int. Cl. H01H 1/60

(52) U.S. Cl. 307/137

(57) ABSTRACT

The present disclosure provides an apparatus and a method for preventing an Intermediate Frequency (IF) connector from being corroded in a portable terminal. The apparatus may comprise an IF connector and a load switch that is mounted in a main board. The load switch is configured to communicate with the IF connector and to prevent a reverse voltage from being applied to the IF connector.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Aug. 18, 2011, and assigned Serial No. 10-2011-0082067, the entire disclosure of which is hereby incorporated by reference.

### TECHNICAL FIELD OF THE INVENTION

The present disclosure is directed, in general, to wireless communication devices and, more specifically, to an apparatus and method for preventing corrosion of an Intermediate Frequency (IF) connector in a portable terminal.

### BACKGROUND OF THE INVENTION

Portable terminals have become necessities for modern life as the electronic communication industry progresses, and they have become a major means of information transmission that change rapidly. A portable terminal may be inspected by applying a voltage with an Intermediate Frequency (IF) connector connected to a jig during the manufacturing process. Referring to FIG. 1, a portable terminal 5 having an IF connector 10 is illustrated. The IF connector 10 may comprise a ground pin (GND) 11, a device identifying distinct signal pin (ID) 12, a data transmitting pin (D+) 13, a data receiving pin (D−) 14, a recharging source pin (VBUS) 15, together with a ground pin (GND) 16 for use in an inspection of RF calibration during manufacturing process of the portable terminal 5, and an operating source pin (VBAT) 17. The IF Connector 10 may be secured in a main board of the terminal 5 to communicate with the main board electrically.

In general, the operating source pin (VBAT) 17 has some level of voltage continuously due to the battery, which may cause the IF connector 10 to become corroded on being flooded.

### SUMMARY OF THE INVENTION

To address the above-discussed deficiencies of the prior art, it is an object to provide an apparatus for preventing an IF connector from being corroded in a portable terminal.

Another purpose of the present disclosure is to provide an apparatus for preventing a reverse voltage from being applied to an IF connector from a battery.

In accordance with the present disclosure, an apparatus for preventing an IF connector from being corroded in a portable terminal is provided. The apparatus comprises the IF connector and a load switch mounted in a main board. The IF connector and the load switch may communicate with each other. The load switch is configured to prevent a reverse voltage from being applied to the IF connector.

In accordance with the present disclosure, the load switch may comprise an input pin connected to the IF connector and an output pin connected to a battery source, and a voltage applied to the output pin may be prevented from being reverse-output to the input pin.

In accordance with the present disclosure, the IF connector may comprise a source pin to which a source provided by an external source supplying device is applied through a jig. The input pin of the load switch is connected to the source pin of the IF connector, and the source applied to the load switch from the input pin is output to the output pin.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a conventional Intermediate Frequency (IF) connector of a portable terminal;

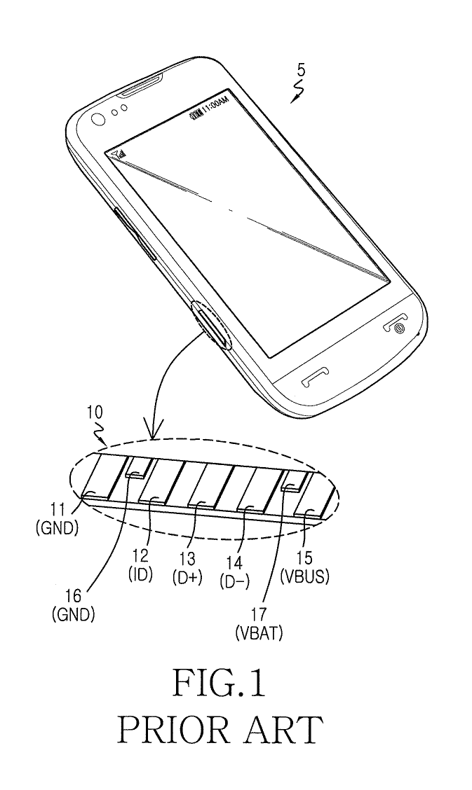

FIG. 2 is a block diagram illustrating an apparatus for preventing an IF connector from being corroded according to an embodiment of the present disclosure;

FIG. 3 is a circuit diagram illustrating an apparatus for preventing an IF connector from being corroded according to an embodiment of the present disclosure; and

FIG. 4 illustrates the circuit diagram of FIG. 3 according to another embodiment of the present disclosure.

### DETAILED DESCRIPTION OF THE INVENTION

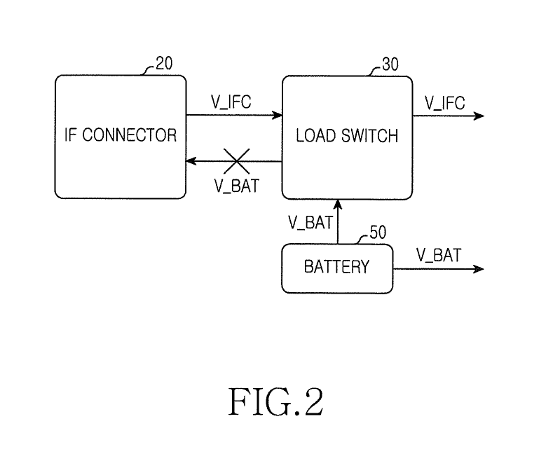

FIGS. 2 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device or system. Exemplary embodiments of the present disclosure will be described herein below with reference to the accompanying drawings. In the following description, well-known functions or constructions are not described in detail since they would obscure the disclosure in unnecessary detail.

The present disclosure relates to an apparatus for preventing an IF connector from being corroded in a portable terminal. As described in more detail below, no voltage is applied to the IF connector from a battery of the portable terminal. Voltage applied from the battery is defined as V_BAT, and voltage applied from the IF connector is defined as V_IFC in the following description.

FIG. 2 is a block diagram illustrating an apparatus for preventing an IF connector from being corroded according to an embodiment of the present disclosure.

Referring to FIG. 2, an apparatus for preventing an IF connector from being corroded according to the present disclosure may comprise an IF connector 20, a load switch 30 and a battery 50. The IF connector 20 may be supplied with V_IFC from an external source supplying device (not shown in FIG. 2), and the supplied V_IFC may be output to the load switch 30 through the V_IFC line. Furthermore, the load switch 30 may be supplied with V_BAT from the battery 50, but the supplied V_BAT is not output to the IF connector 20 through a V_BAT line connecting the IF connector 20 and the load switch 30. In other words, the load switch 30 may prevent a reverse voltage (or reverse current) from being applied to the IF connector 20 from the battery 50. According to that structure, a voltage from the IF connector 20 to the V_BAT of the battery 50 is not applied, and hence corrosion of the IF connector 20 due to being flooded may be prevented.

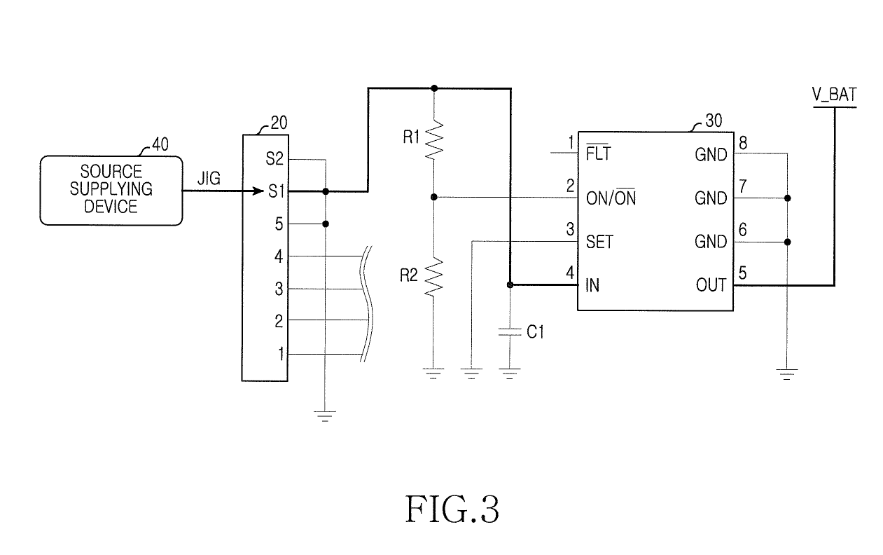

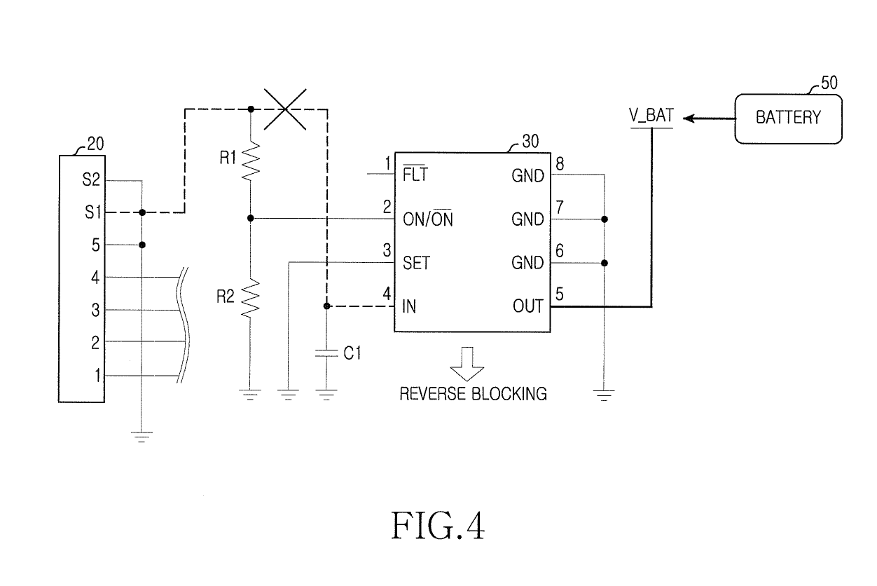

FIG. 3 and FIG. 4 are circuit diagrams illustrating an apparatus for preventing an IF connector from being corroded according to embodiments of the present disclosure.

An apparatus for preventing an IF connector being corroding may comprise an IF connector 20 and a load switch 30 for preventing a reverse voltage. The IF connector 20 may comprise a ground pin (GND), a device identifying distinct pin (ID), a data transmitting pin (D+), a data receiving pin (D−) and a recharging source pin (V_BUS), together with a ground pin (GND) for use in inspection of RF calibration, etc., during a manufacturing process, and an operating source pin (V_IFC). Those pins may be coupled to lines wired previously in a main board. For some embodiments, the load switch 30 may have a relatively small size and may comprise a MOSFET switch having low loss because it has low Resistance between Drain and Source (RDS) (on). For some embodiments, the value of RDS (on) of the load switch 30 may be about 130 to 135 mΩ. Furthermore, the load switch 30 may operate normally at a maximum current value above 2 A.

The load switch 30 may comprise a pin F̅L̅T̅ related to fault flag operation, a pin ON/ O̅N̅ related to enable input, a pin SET related to current limit set, a pin IN related to load switch power supply input, a pin OUT related to current limiting output and at least one pin GND related to grounding.

In particular, ON/ O̅N̅ may be coupled to the V_IFC (pin number S1) of the IF connector 20, but a pull down resistor R2 may be included in order to prevent ON/ O̅N̅ from being floated. SET may be coupled to ground and a resistor (not shown in FIG. 3 or FIG. 4) may be included between SET and ground for some embodiments. Furthermore, IN may be coupled to the V_IFC of the IF connector 20, but may be bypassed using a capacitor C1 between IN and ground. According to an embodiment of the present disclosure, the capacitance of the capacitor C1 may be about 1 μF.

Furthermore, if a pin (for example, ID) of the IF connector 20 exists to which the battery source (V_BAT) is applied, that pin may cause an error input related to ON/ O̅N̅ from that pin to the V_IFC pin on being flooded due to the application of the V_BAT. As shown in FIG. 3, another resistor R1 for branching an enable input value (input signal) to the ON/ O̅N̅ pin may be added. As result, the enable input value may be divided as R1/(R1+R2) to resolve the above-mentioned problem. For some embodiments, the resistance value of R1 may be about 100 kΩ and that of R2 may be about 200 kΩ.

Referring to FIG. 3, if the IF connector 20 is coupled to a jig, V_IFC may be supplied to the IF connector 20 from an external source supplying device 40 through the jig, and the supplied V_IFC may be supplied from the IF connector 20 to the input pin IN of the load switch 30. The load switch 30 may output V_IFC supplied from the IF connector 20 to the output pin OUT. V_IFC output from the output pin OUT may be output to a V_BAT line for operating a portable terminal. The embodiment shown in FIG. 3 illustrates a configuration to operate the terminal by connecting the jig without using a battery when the terminal is inspected.

Referring to FIG. 4, when the load switch 30 is coupled to the battery 50, V_BAT of the battery 50 may be applied to the output pin OUT of the load switch 30 through the V_BAT line. For this embodiment, the load switch 30 does not reverse-output the V_BAT of the battery 50 being applied to the output pin OUT to the input pin IN, and corrosion of the IF connector 20 due to being flooded may be prevented since the V_BAT of the battery 50 is not applied to the V_IFC pin (pin number S1) of the IF connector 20.

In conclusion, corrosion of the IF connector 20 due to being flooded may be prevented since a reverse voltage is not applied to the IF connector 20 according to the present disclosure.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. An apparatus for preventing an intimidate frequency (IF) connector from being corroded in a portable terminal, the apparatus comprising:
an IF connector; and
a load switch mounted in a main board, wherein the load switch is configured to communicate with the IF connector and to prevent a reverse voltage from being applied to the IF connector.

2. The apparatus of claim 1, wherein the load switch comprises an input pin coupled to the IF connector and an output pin coupled to a battery source, and wherein the load switch is configured to prevent a reverse voltage from being applied to the IF connector by preventing a voltage applied to the output pin from being reverse-output to the input pin.

3. The apparatus of claim 2, wherein the IF connector comprises a source pin configured to provide a source received from an external source supplying device through a jig, wherein the input pin of the load switch is coupled to the source pin of the IF connector and configured to receive the source, and wherein the load switch is further configured to output to the output pin the source that is applied to the load switch through the input pin.

4. The apparatus of claim 3, further comprising a capacitor configured to bypass the input pin of the load switch to a ground of the main board.

5. The apparatus of claim 4, wherein the capacitance of the capacitor is about 1 μF.

6. The apparatus of claim 3, wherein the load switch comprises an enable input pin, and the enable input pin is coupled to the source pin of the IF connector and to a pull down resistor that is configured to prevent the enable input pin from being floated.

7. An apparatus of claim 6, further comprising a dividing resistor that is configured to divide a resistance input to the enable input pin.

8. The apparatus of claim 7, wherein the resistance of the pull down resistor is about 200 kΩ and the resistance of the dividing resistor is about 100 kΩ.

9. The apparatus of claim 1, wherein the load switch is further configured to allow for a maximum current above 2 A.

10. The apparatus of claim 1, wherein a Resistance between Drain and Switch (RDS) (on) of the load switch is about 130 to 135 mΩ.

11. The apparatus of claim 1, wherein the IF connector comprises a ground pin, a device identifying distinct signal pin, a data transmitting pin, a data receiving pin, a recharging source pin, a ground pin for inspecting a terminal and an operating source pin.

12. The apparatus of claim 1, wherein the load switch comprises an enable input pin, a current limit set pin, a source supplying input pin, a current limit output pin and a ground pin.

13. An apparatus for preventing an intimidate frequency (IF) connector from being corroded in a portable terminal, the apparatus comprising:
an IF connector configured to receive as an input a source from a source supplying device and to provide as an output the source; and
a load switch comprising an output pin that is coupled to a battery line and an input pin,
wherein the battery line is configured to provide power for operating a portable terminal,
wherein, for inspection of the portable terminal, the input pin is configured to receive the source from the IF connector, and
wherein, for operation of the portable terminal, the input pin is configured to prevent a reverse voltage from being applied to the IF connector.

14. The apparatus of claim 13, wherein, for inspection of the portable terminal, the output pin is configured to provide as an output the source, and the battery line is configured to receive the source provided as the output from the output pin.

15. The apparatus of claim 13, wherein, for operation of the portable terminal, the portable terminal comprises a battery coupled to the battery line, the battery is configured to provide a battery voltage, and the output pin is configured to receive the battery voltage from the battery through the battery line.

16. The apparatus of claim 13, wherein the source supplying device comprises an external source supplying device, and wherein the IF connector is configured to receive as the input the source from the external source supplying device through a jig.

17. A method for preventing an intimidate frequency (IF) connector from being corroded in a portable terminal, the method comprising:
providing a source as an output from an IF connector;
coupling an input pin of a load switch to the IF connector;
coupling an output pin of the load switch to a battery line, wherein the battery line is configured to provide power for operating a portable terminal;
for inspection of the portable terminal, receiving the source from the IF connector at the input pin; and
for operation of the portable terminal, preventing a reverse voltage from being applied to the IF connector through the input pin.

18. The method of claim 17, further comprising, for inspection of the portable terminal, providing the source as an output from the output pin to the battery line.

19. The method of claim 17, further comprising, for operation of the portable terminal, receiving a battery voltage from a battery through the battery line.

20. The method of claim 17, further comprising receiving the source as an input at the IF connector from an external source supplying device through a jig.
